(19) United States
(12) Patent Application Publication
(10) Pub. No.: US 2011/0171937 A1
(43) Pub. Date: Jul. 14, 2011

(54) PERSONAL DIGITAL NOTIFICATION SYSTEM, APPARATUS, AND METHOD

(75) Inventors: Myra Vazquez Hill, Boca Raton, FL (US); Nancy Vazquez Register, Austin, TX (US); Rong Yin, Austin, TX (US)

(73) Assignee: Personal Digital Notification Systems, LLC, Boca Raton, FL (US)

(21) Appl. No.: 12/687,243

(22) Filed: Jan. 14, 2010

(51) Int. Cl. H04L 12/58; H04B 7/005

(52) U.S. Cl. 455/412.2; 455/41.3; 340/539.11

(57) ABSTRACT

A system, method, and apparatus for receiving notifications from a notifying device, and alerting a user as to the notification are provided. Embodiments of the present invention include a connectivity transceiver, and a notifying device transceiver positioned within a signal distance of a signal transmitted by the connectivity transceiver, wherein the connectivity controller is configured to set the signal distance to a reduced signal distance upon initiating a pairing operation with the notifying device transceiver. Further, the connectivity transceiver may be communicably coupled to a system controller that adjusts an interval duty cycle of inquiry scans and page scans based on a connection with the notifying device transceiver.

### BACKGROUND

Mobile device users desire timely event notifications from their various mobile devices. Such devices employ various conventional methods to inform users of events. For example, some devices may use ring tones and vibrations to inform users of incoming telephone calls and messages. In contrast, other devices may use audio alerts and display animations to inform users about events (e.g., a graphical user interface of the device may show an envelope icon to alert the user to incoming mail, or a pop-up reminder to alert the user to a scheduled meeting). Users typically have the opportunity to define their preferences about event notifications.

In order to receive these event notifications, users must have direct interface with the associated devices by hearing, feeling, and seeing the various forms of notification. However, a device's audible event notification may not be perceived by the user in a noisy environment. Similarly, another user may not easily feel the vibration of a mobile telephone if the device is in a purse, briefcase, or somewhere not having direct physical contact with the user. Visual event notifications are also ineffective if the user does not have visual contact with the device's display screen. Because a typical user may use multiple mobile devices at any one time, it is often inconvenient or bulky to clip or attach all of these devices to the user, such as attaching them to the user's belt. Therefore, a user may miss an event notification and suffer unintended consequences, especially if the event is an important telephone call or appointment.

### SUMMARY

In view of the limitations of conventional notification systems, there is a need for a personal digital notification system that can improve the way users are alerted to notifications received from their various mobile devices, such as by affixing or attaching a digital notification apparatus to an article of clothing or directly to a user's skin. There is also a need for software that may be installed on a notifying device that is configured to capture application and network events, and translate the events into Bluetooth data signals.

One of the broader forms of an embodiment of the invention involves an apparatus that includes a connectivity transceiver configured to exchange data with a notifying device transceiver that is positioned within a signal distance of a signal transmitted by the connectivity transceiver, and a connectivity controller communicably coupled to the connectivity transceiver. The connectivity controller is configured to code and decode data that is sent and received by the connectivity transceiver, wherein the signal distance of the signal transmitted by the connectivity transceiver is controlled by the connectivity controller. The apparatus also includes a power management system electrically coupled to a battery, the connectivity controller, and the connectivity transceiver wherein the power management system is configured to regulate power output to each of the connectivity controller and the connectivity transceiver. A system controller is communicably coupled to each of the connectivity transceiver, the connectivity controller, the alert system, and the power management system, and the system controller is configured to control the operation of each of the connectivity transceiver, the connectivity controller, the alert system, and the power management system. Furthermore, the alert system outputs an alert when the connectivity controller receives a notification from the notifying device transceiver. Upon initiating a pairing operation with the notifying device transceiver, the connectivity controller sets the signal distance to a reduced signal distance.

Another one of the broader forms of an embodiment of the invention involves a method of operating a personal digital notification system device that includes a connectivity transceiver configured to exchange data with a notifying device transceiver positioned within a signal distance of a signal transmitted by the connectivity transceiver. The method includes setting the signal distance to a reduced signal distance upon initiating a pairing operation with the notifying device transceiver, and pairing the personal digital notification system device with the notifying device transceiver when it is positioned within the signal distance of the signal transmitted by the connectivity transceiver.

Yet another one of the broader forms of an embodiment of the invention involves a system that includes at least one mobile device, and a personal digital notification device worn in close physical contact with the user, and positioned within a predetermined signal distance to the at least one mobile device. The personal digital notification device is configured to set the signal distance to a reduced signal distance upon initiating a pairing operation with the mobile device, where the personal digital notification device is operable to provide an alert perceivable by the user upon receiving a notification from the at least one mobile device.

### BRIEF DESCRIPTION OF THE DRAWINGS

Aspects of the present disclosure are best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 is a simplified diagram illustrating an exemplary system in accordance with one or more aspects of the present disclosure;

FIGS. 2a-2b are diagrammatic views illustrating exemplary personal digital notification system devices in accordance with one or more aspects of the present disclosure;

FIG. 3 is a simplified block diagram of an exemplary personal digital notification system device in accordance with one or more aspects of the present disclosure;

FIG. 4 is a flowchart of an exemplary process in accordance with one or more aspects of the present disclosure;

FIG. 5 is a flowchart illustrating an exemplary process of pairing an exemplary personal digital notification system device with a notifying device in accordance with one or more aspects of the present disclosure;

FIG. 6 is a block diagram of an exemplary notifying device in accordance with one or more aspects of the present disclosure; and

FIG. 7 is a flowchart of an exemplary process in accordance with one or more aspects of the present disclosure;

### DETAILED DESCRIPTION

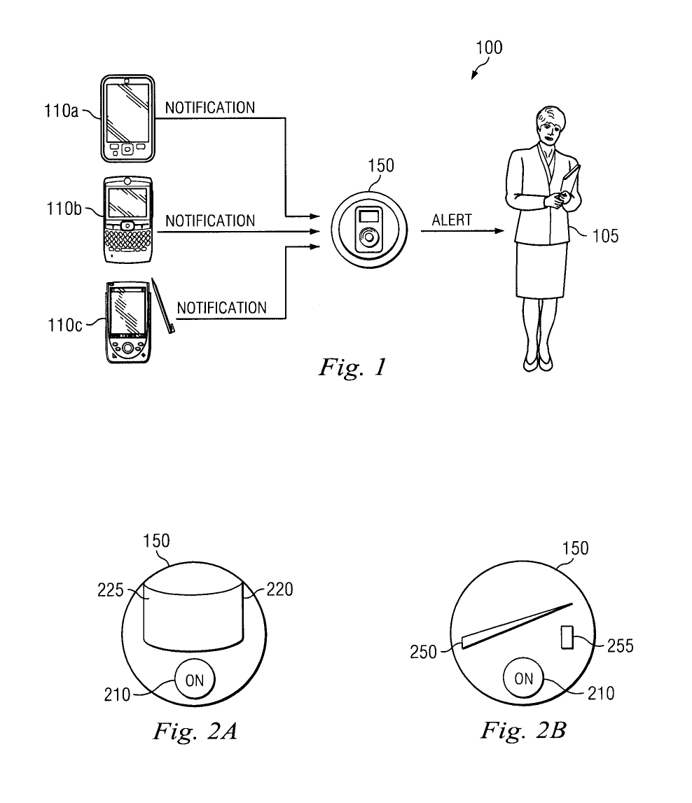

FIG. 1 is a simplified diagram of an exemplary system 100 for notifying a user 105 of notifications generated by various notifying devices 110 a-c. For example, a notification may include notification of an incoming telephone call, a calendar appointment, a voicemail, a missed call, an incoming message (e.g., a text message), or an event detected by an application installed on the notifying device 110 (e.g., “Twitter,” “AOL Instant Messenger,” “Facebook,” etc.). The foregoing are merely examples of a “notification,” and it should be understood that a notification may include any kind of notification of an event perceivable or received by the mobile device.

The exemplary notifying devices 110a-c shown in FIG. 1 include smartphones 110a and 110b, and a personal digital assistant 110c. Other examples of notifying devices may include any mobile devices that is capable of generating a notification, such as a netbook, a laptop, an electronic component of an automobile, and any other mobile electronic device now known or to be developed in the future.

The notifying devices 110a-c send notifications to a personal digital notification system 150, and upon receiving a notification, the personal digital notification system 150 sends an alert to the user 105. Alerts are signals that are transmitted by the personal digital notification system 150 to the user 105 to indicate a notification. Alerts may take various forms, including without limitation, sound, heat, electric stimulation, and vibration.

FIG. 2a is a diagrammatic view illustrating an exemplary personal digital notification system 150 in accordance with one or more aspects of the present disclosure. The personal digital notification system 150 includes a power button 210 that may be depressed by a user 105 to power the personal digital notification system 150 on and off. Further, a band 220 is coupled or bonded to the personal digital notification system 150, and is operable to removably couple or attach the personal digital notification system 150 to the user 105. The band 220 may include an adhesive surface that adheres to either the user's 105 skin or an article of clothing worn by the user 105. The adhesive surface may include any conventional adhesive. Alternatively, the band 220 may be an elastic band to enable the personal digital notification system 150 to be worn in the user's hair. The band 220 may also be adjustable to fit a user's finger as a ring, or to be worn as a necklace, bracelet, earring, or another type of jewelry, for example. The personal digital notification system 150 may be adorned with decorative designs for ornamental purposes.

FIG. 2b is a diagrammatic view illustrating another exemplary personal digital notification system 150 in accordance with one or more aspects of the present disclosure. The personal digital notification system 150 includes a pin 250 that may be removably coupled to an article of clothing worn by the user 105, and secured using the clip 255. This embodiment may be worn as a brooch or pin, a hair barrette in the user's hair, or a tie clip to secure the user's tie. Alternatively, the personal digital notification system 150 may be worn as a cuff link, or clipped to a waistband, for example. It should be understood that the embodiments of the personal digital notification system 150 shown in FIGS. 2a-2b and described herein are merely representative, and that the personal digital notification system 150 is affixable to an article of clothing or directly to the user 105.

The personal digital notification system 150 may have the size and shape of a quarter coin or smaller. However, it should be understood that the personal digital notification system 150 may take on any size and shape. As discussed above, the personal digital notification system 150 may be attached to an article of clothing. The article of clothing may enable discreet direct contact with the user's 105 skin, such as a bra strap, a glove, or an underwear waistband. Securely attaching the personal digital notification system 150 to such articles of clothing allows the personal digital notification system 150 to be discreetly worn during operation. Furthermore, allowing the personal digital notification system 150 to be worn close to the body of the user 105, or directly affixed to the user's 105 skin, reduces the possibility that the user 105 will miss an event notification, at least because the device will always be in physical contact with the user 105. An advantage of securing the personal digital notification system 150 to an undergarment is that the user 105 is unlikely to remove such articles of clothing in public, and therefore, the user can perceive all notifications and that chances of losing the personal digital notification system 150 are greatly reduced.

Unlike conventional Bluetooth headsets that are worn close to the ear, the personal digital notification system only provides one-way alert of an event notification from a notifying device 110 to the personal digital notification system 150, and does not provide wireless two-way communication/conversation between the personal digital notification system 150 and the notifying device 110. Accordingly, power consumption by the personal digital notification system 150 can be greatly reduced. Furthermore, as compared to conventional Bluetooth headsets, embodiments of the personal digital notification system 150 enable flexible placement with respect to the notifying devices 150. For example, conventional Bluetooth accessories are designed to be affixed to specific portions of a user's body (e.g., close to the ear). In contrast, embodiments of the personal digital notification system 150 may be placed practically anywhere near or onto a user's body.

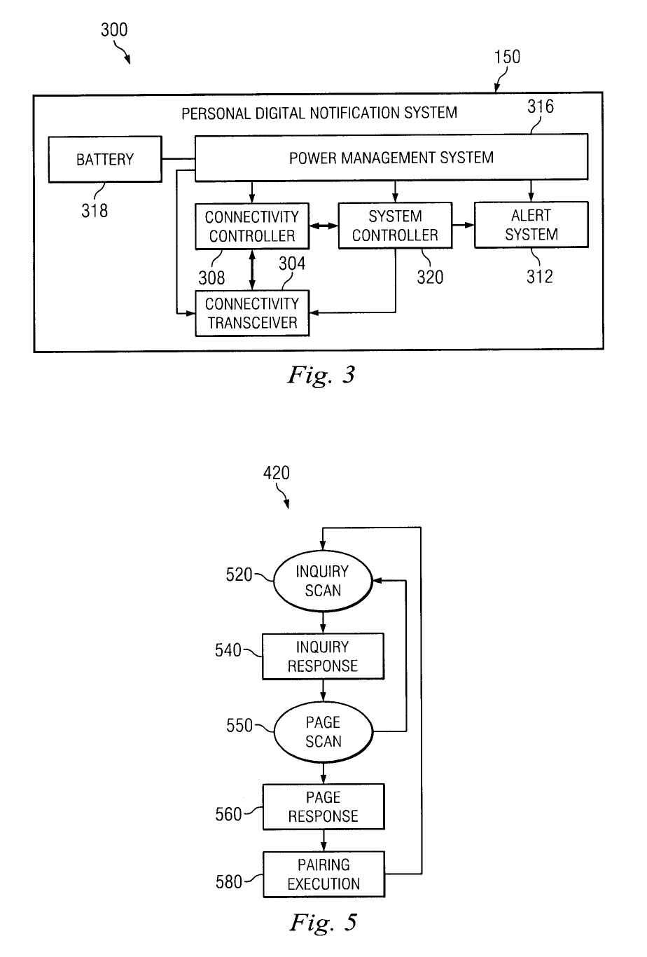

Referring now to FIG. 3, block diagram 300 illustrates the various subsystems that are included in the personal digital notification system 150. The personal digital notification system 150 includes a connectivity transceiver 304, a connectivity controller 308, an alert system 312, a power management system 316, a battery 318, and a system controller 320.

Connectivity transceiver 304 transmits and receives data to and from a notifying device 110a-c, such as a smartphone, digital personal assistant, and another mobile device. The connectivity transceiver 304 may use conventional Bluetooth protocols to exchange data with the notifying devices 110a-c. In other embodiments, the personal digital notification system 150 and the notifying devices 110a-c may communicate using other short-range wireless communications technologies, such as Nokia's Wibree short-range wireless technology. Other protocols now known and to be developed may be used.

The connectivity controller 308 is communicably coupled to the connectivity transceiver 304, and is configured to code and decode data that is sent and received by the connectivity transceiver 304. Alert system 312 is configured to output alerts to the user 105 in one or more selected form.

The power management system 316 is coupled to the battery 318, the connectivity controller 308, the connectivity transceiver 304, the alert system 312, and the system controller 320. A function of the power management system 316 is to regulate power use within the personal digital notification system 150. The battery 318 can be any rechargeable or non-rechargeable battery.

The system controller 320 is coupled to each of the connectivity transceiver 304, the connectivity controller 308, alert system 312, and the power management system 316. The system controller 320 controls overall operation of the personal digital notification system 150. As discussed in further detail below, the system controller subsystem 320 controls the operations of the personal digital notification system 150 such as device pairing, connection management, message processing, and the alert system's alert output.

In addition to the foregoing components, the personal digital notification system 150 may also include various other components to enable the methods of notifying the user 105. For example, the personal digital notification system 150 may include a motor that is used to implement a vibration alert. Alternatively, the personal digital notification system 150 may include a speaker that is used to implement an audio alert.

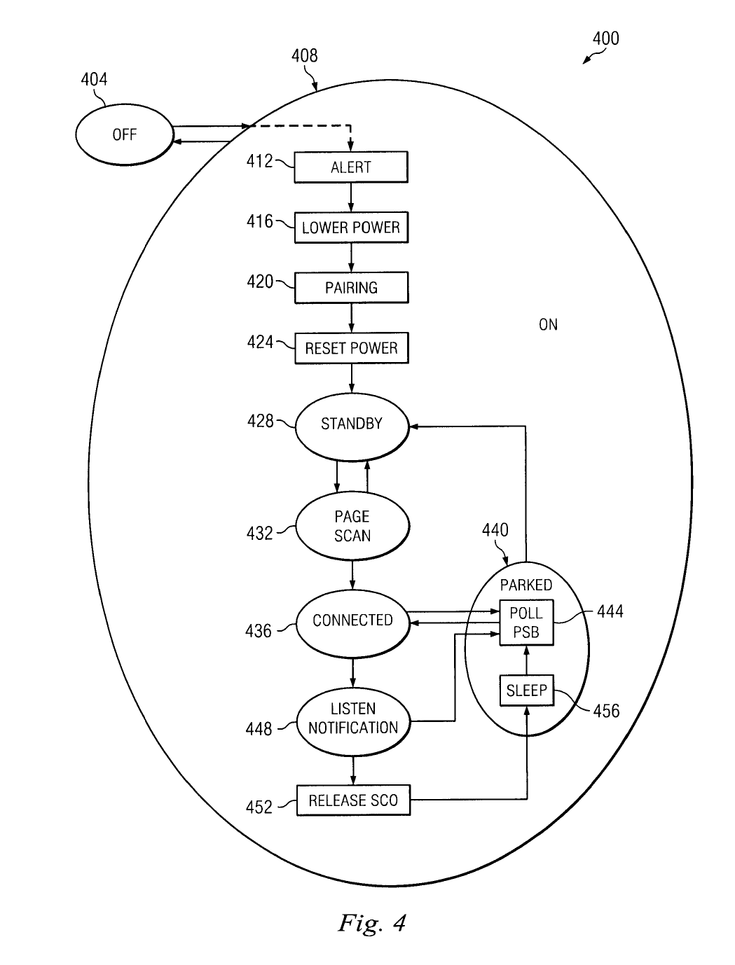

Referring now to FIG. 4, with continued reference to FIGS. 1-3, a flowchart illustrates an exemplary method 400 of the system controller 320. The operation of system controller 320 includes two sub-states: “off state” 404 and “on state” 408. When the personal digital notification system 150 is powered off, it does not use any battery power. The user may transition the personal digital notification system 150 between the off state 404 and the on state 408 by pressing the power button 210.

During the on state 408, the system controller 320 regulates the power provided by the battery 318 to the various components of the personal digital notification system 150. Optionally, the system controller 320 may instruct the alert system 312 to output an alert at “alert state” 412 (e.g., cause the personal digital notification system 150 to vibrate) when the system controller 320 transitions from the off state 404 to the on state 408.

When the personal digital notification system 150 is powered on, the system controller 320 proceeds to “lower power state” 416 in preparation for pairing operations, which will be described below with respect to the pairing state 420. During the lower power state 416, the system controller 320 instructs the power management system 316 to set the power output level to a low “pairing” power level. When the power output level is at the “pairing” power level, the signal distance of the Bluetooth radio signal transmitted by the connectivity transceiver 304 is set to a reduced signal level so that the signal is only detectable by notifying devices 110 that are positioned within a very short predetermined distance of the personal digital notification system 150. As an example, the pairing signal distance may be approximately one inch. Alternatively, the pairing signal distance may be between two and ten inches.

A pairing operation that automatically pairs devices within a radio signal range may be referred to as “secure simple pairing” (SSP). In conventional pairing operations, devices that initiate pairing will set the radio signal to an increased signal level in order to allow connecting devices to be conveniently located further away from the initiating device. However, setting the radio signal to an increased signal level when performing an SSP operation may cause such devices to pair with unauthorized or undesired devices. As discussed with respect to embodiments of the present disclosure, minimizing the range of the “pairing” signal distance to a short distance helps to prevent an unauthorized or undesired Bluetooth-enabled device from pairing with the personal digital notification system 150.

In the “pairing state” 420, the system controller 320 attempts to automatically “pair” with notifying devices 110a-c (i.e., identify notifying devices 110) using conventional Bluetooth pairing operations. Referring briefly to FIG. 5, an exemplary process of a pairing state 420 is shown. An “inquiry scan” identifies requests from a notifying device 110 to pair. Beginning at block 520, an inquiry scan is initiated in order to identify notifying devices 110 that may be paired with the personal digital notification system 150. At block 540, any inquiry response is processed. To reduce battery usage requirements, the system controller 320 dynamically adjusts the interval duty cycle of inquiry scans. Every time the system controller 320 receives a valid inquiry response from a paired notifying device 110, it increases the duty cycle of the next inquiry scan.

A “page scan” identifies requests to connect and send data from a notifying device 110 that is paired with the personal digital notification system 150. A page scan is initiated at block 550 in order to identify paired notifying devices 110 that are trying to connect to the personal digital notification system 150 and send data. The page scan at block 550 may time out after a predetermined amount of time, and return to block 520 to perform an inquiry scan. However, if a page response is detected within the predetermined amount of time, then the page response is processed at block 560, and pairing is executed at block 580 using conventional Bluetooth pairing operations. To reduce battery usage requirements, the system controller 320 dynamically adjusts the interval duty cycle of page scans. The system controller 320 starts with a large duty cycle of page scans and reduces the duty cycle to a smaller duty cycle upon responding to a connection inquiry during the page scan.

Upon completion of pairing execution, the pairing state 420 returns to block 520, and repeats according to a predetermined schedule. The pairing state 420 shown in FIG. 5 is merely representative, and other methods of pairing the personal digital notification system 150 with notifying devices 110 may be used in other embodiments.

Referring again to FIG. 4, with continued reference to FIGS. 1-3, during the pairing state 420, the system controller 320 automatically pairs with any notifying devices 110 that are within receiving distance of the personal digital notification system's Bluetooth radio signal during a predetermined period of time. Optionally, when the system controller 320 successfully pairs with one or more notifying devices 110, the system controller 320 instructs the alert system 312 to output an alert. The system controller 320 automatically times out if the personal digital notification system 150 is not able to pair with any notifying device 110 after the predetermined period of time.

In other embodiments, the notifying device 110 may implement a Bluetooth specification version that uses a fixed personal identification number (PIN) code. In such embodiments, before the personal digital notification system 150 pairs with the notifying device 110, the user must enter, via an interface provided by the notifying device 110, a PIN code that matches a predetermined PIN code set by the personal digital notification system 150. In an embodiment, the user triggers a new pairing operation by pressing the power button 210 once to turn the personal digital notification system 150 off, and then pressing the power button 210 again to turn the personal digital notification system 150 back on. When the personal digital notification system 150 is back on, a new pairing operation, such as the one shown in FIG. 5 is initiated. In another embodiment, the user may press and hold the power button 210 for a predetermined period of time to initiate another pairing operation (e.g., the user 105 wants to pair the personal digital notification system 150 with another notifying device 110). Accordingly, multiple notifying devices may be paired with the personal digital notification system 150.

The device pairing operation discussed above with respect to the pairing state 420 is different from conventional Bluetooth device pairing operations, at least because conventional devices often require interaction with an interface to initiate pairing. Furthermore, with conventional Bluetooth devices, during the attempted pairing operation, such conventional devices will increase, rather than decrease, the power of an associated Bluetooth transceiver to facilitate the device discovery process. In contrast, with embodiments of the personal digital notification system 150, the pairing operation automatically begins when the personal digital notification system 150 is powered on, and the personal digital notification system 150 reduces the range of the Bluetooth signal so that the personal digital notification system 150 automatically pairs only with devices that are within a short range of the Bluetooth signal. As discussed above, this helps prevent an unauthorized or undesired Bluetooth-enabled device from pairing with the personal digital notification system 150.

Once the pairing operation is complete (i.e., the personal digital notification system 150 has paired with one or more notifying devices 110, or the pairing operation has timed out), the system controller 320 enters a “reset power state” 424. During the reset power state 424, the system controller 320 provides a signal to the power management system 316, and instructs it to set the battery's 318 power output to a “standby” power level that will enable the connectivity transceiver 304 to receive Bluetooth signals from notifying devices 110 that are within a predetermined distance with respect to the personal digital notification system 150. This predetermined distance may be longer than the required distance between the personal digital notification system 150 and the notifying device 110 during the pairing state 420, and may be determined depending on the typical expected distance between notifying devices 110 and the personal digital notification system 150 during use. For example, the predetermined distance may be the same or less than the required distance between the personal digital notification system 150 and the notifying device 110 during the pairing state 420. However, in other embodiments, this predetermined distance may be the maximum signal distance supported by the connectivity transceiver 304.

The system controller 320 then cycles between the “standby state” 428 and the “page scan state” 432. During the standby state 428 the system controller 320 waits for a predetermined period of time, and then proceeds to the page scan state 432. During the page scan state 432, the system controller 320 instructs the connectivity controller 308 to perform a page scan for a predetermined period of time in order to identify devices that are requesting to connect to the personal digital notification system 150 and send data.

During the page scan, the connectivity controller 308 listens for a paging message transmitted by a notifying device 110. If, during this predetermined period of time, the connectivity controller 308 does not receive a paging message, then the system controller 320 returns to the standby state 428.

The standby state 428 and paging state 432 implemented by the system controller 320 have an efficiency advantage over conventional Bluetooth devices. Conventional Bluetooth devices implement connection establishment procedures that use predefined duty cycles for inquiry scans and page scans that may occur as often as every fifteen (15) seconds to every half (½) second. A reason for having such frequent inquiry and page scans is that such conventional devices may need to constantly monitor for new connection inquiries, and are designed to minimize the possibility of missing any possible activity related to a notifying device. In contrast, an advantage of the personal digital notification system 150 over conventional Bluetooth devices is that the system controller 320 dynamically varies the inquiry and page scan duty cycles. As a result, the embodiments of personal digital notification system 150 device are able to significantly reduce battery consumption, as compared to conventional technologies.

If the connectivity controller 308 receives a paging message during the page scan state 432, then the system controller 320 will attempt to establish an asynchronous connection-oriented (ACL) connection with the paired notifying device 110 that sent the paging message. Upon establishing the ACL connection with the corresponding paired notifying device 110, the system controller 320 enters the “connected state” 436. Optionally, the system controller 320 may instruct the alert system 312 to output an alert upon successfully establishing an ACL connection.

Upon establishing a connection with a paired notifying device 110, the system controller 320 proceeds to the “parked state” 440. While in the parked state 440, the system controller 320 will proceed to the standby state 428 if the system controller 320 detects a loss of radio signals. Loss of radio signals may occur, for example, when a connected notifying device 110 moves out of the connectivity transceiver's 304 reception range.

Furthermore, during the parked state 440, the system controller 320 periodically polls notifying devices 110 for Parked Slave Broadcast (PSB) messages at a “poll PSB state” 444. Polls may occur at predetermined intervals, or at varying intervals. When a connected notifying device 110 sends a notification message to the personal digital notification system 150, it will send an “unpark” PSB message to the personal digital notification system 150.

When the system controller 320 receives an “unpark” PSB message from a connected notifying device 110, the system controller 320 returns to the connected state 436, and proceeds to “listen notification state” 448. During the listen notification state 448, the system controller 320 instructs the connectivity controller 308 to listen for notification messages from a connected notifying device 110. If the system controller 320 determines that the connectivity controller 308 has received a notification from a connected notifying device 110, the system controller 320 instructs the alert system 312 to output an alert that is associated with the notification.

The alert system 312 is programmed to include a set of alert variations that are used to indicate different types of notifications received from notifying devices 110. For example, a set of variations may include the following variations: three short vibrations, five short vibrations and seven short vibrations, where each short vibration lasts one half of a second. Three short vibrations indicate an incoming SMS notification, five short vibrations indicate an incoming e-mail notification, and seven short vibrations indicate an incoming phone call notification. Another set of variations may include the following variations: one long vibration, two long vibrations, and three long vibrations, where each long vibration lasts two seconds. One long vibration indicates incoming calls from others, two long vibrations indicate incoming calls from friends, and three long vibrations indicate incoming calls from family members. In other embodiments, combinations of long and short vibrations may be used to identify the notifying device 110 that sent a notification.

In an embodiment, in order to conserve battery life, the system controller 320 initiates sleep for a predetermined time at the sleep state 456 upon instructing the alert system 312 to output an alert. A motivating reason for the foregoing behavior is that the user is likely to access the connected notifying device 110 upon receiving an alert. During such time, it may not be necessary to continue sending alerts to the user. However, in other embodiments, the system controller 320 may not sleep at the sleep state 456 upon instructing the alert system 312 to output an alert, and may instead proceed directly to the poll PSB state 444.

At the listen notification 448 stage, in addition to listening for notification messages, the system controller 320 may process a subset of other messages that are received from a connected notifying device 110. This subset may include messages that include information related to the notification event (e.g., information about incoming calls, incoming e-mails, incoming SMS messages, incoming calendar events, incoming Twitter content, etc.). Furthermore, these messages may provide information that the personal digital notification system 150 can present to the user 105 along with the alert.

After a predetermined period of time after receiving a notification, the system controller 320 returns to the poll PSB state 444. As discussed above, during the poll PSB state 444, the system controller 320 will periodically poll notifying devices 110 for PSB messages. If, after a predetermined period of time, no PSB messages are received, then the system controller returns to the standby state 428.

The system controller 320 is programmed to ignore certain messages, such as phone conversation data. For phone conversations, and other ignored messages, a subset of the Hands-Free Profile (HFP) protocol, Headset Profile (HSP) protocol, or other protocol, are implemented. As an example, a Synchronous Connection-Oriented (SCO) connection may be used by the connected notifying device 110 to carry audio signals.

Processing audio signals from a notifying device may require a significant increase in battery 318 usage. In order to minimize battery consumption, if the system controller 320 receives a notification at the listen notification stage 448 that indicates an incoming telephone call, and the system controller 320 receives a SCO connection request from a connected notifying device 110, then the system controller 320 accepts the SCO connection, and proceeds to the “release SCO state” 452. At the release SCO state 452, the system controller 320 instructs the connectivity controller 308 to release any SCO connections. After an SCO connection is released, the personal digital notification system 150 will not process any audio signals transmitted via the SCO connection. As discussed above, such audio signals may be processed by other devices using various conventional profile protocols.

Once the SCO connection is released, the system controller 320 proceeds to the sleep state 456 of the parked state 440. The foregoing functionality helps extend battery 318 life, because the system controller 320 does not process the audio signals. To reduce battery 318 usage, the system controller 320 sleeps (i.e., instructs the power management system 316 to reduce power output) for a predetermined time at the sleep state 456 before proceeding to the poll PSB state 444.

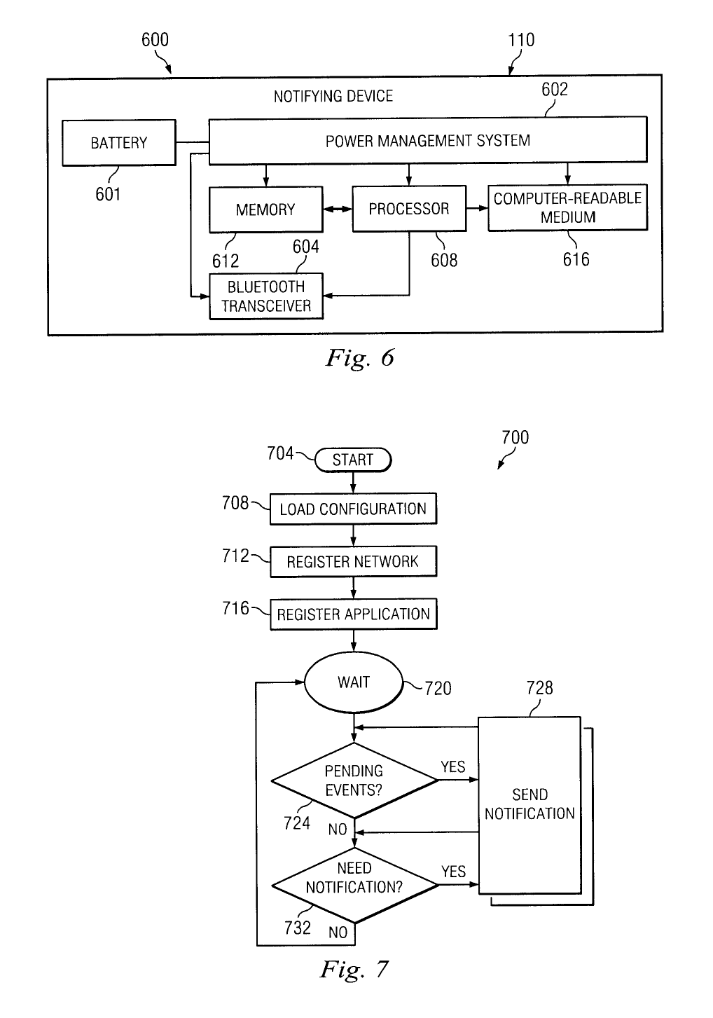

Referring now to FIG. 6, a notifying device 110 may include, among other conventional components, a battery 601, a power management system 602, a Bluetooth transceiver 604, a processor 608, a memory 612, and a computer-readable medium 616. The power management system 602 is coupled to the battery 601, and controls the distribution of power to the components of the notifying device 110. The computer-readable medium 616 includes device software that includes instructions executable by the processor 608. One function of the device software is to use application interfaces provided by other software installed on the computer-readable medium 616 and/or memory 612 to manage notifications that will be sent to the personal digital notification system 150. For example, the device software may use an interface provided by an e-mail application to detect incoming e-mail messages. As another example, the device software may use an interface provided by a calendar application to identify calendar appointments and reminders.

The device software also uses Bluetooth interfaces provided by other software installed on the computer-readable medium to send notifications to the paired personal digital notification system 150 via the notifying device's 110 Bluetooth transceiver. For example, upon identifying a notification, such as an incoming e-mail, a calendar appointment, or a calendar reminder, the device software sends an appropriate notification to the paired personal digital notification system 150 using the Bluetooth transceiver 604.

Referring now to FIG. 7 with continued reference to FIGS. 1 and 6, an exemplary method 700 of operating the device software is illustrated in FIG. 7. When the device software is initialized, it begins at block 704, and proceeds to block 708. At block 708, the device software loads configuration values into the memory 612. Configuration values include types of applications installed on the notifying device 110, and application events that have an associated notification. In other embodiments, the device software may also load other configuration values into the memory 612.

Upon loading configuration values, the device software proceeds to block 712. At block 712, the device software registers callback functions for network events. Typical network events include signing on and off a cellular network, signing on and off a wireless network, turning on and off the Bluetooth transceiver 604, and connecting and disconnecting to other Bluetooth devices such as the personal digital notification system 150. At block 716, the device software registers callback functions associated with application events. Application events include incoming calls, incoming SMS messages, incoming e-mail messages, and calendar events.

An application event or a network event may be an event that is not reported to a user 105 when the device software is not enabled. For example, when the device software is not enabled, the notifying device 110 may not inform the user that a new version of an application is available for install, because the application and/or the notifying device 110 may not be programmed to support such functionality. However, when the device software is enabled, the device software may be configured to check for application version updates, and inform the user when a version update is available. Thus, the device software may be customized to notify the user 105 of events that are not reported by applications and/or the notifying device 110.

The device software may also be configured to identify specific events. For example, in an embodiment, the device software may be configured to only output a notification in response to a telephone call from a specific phone number. In another embodiment, the device software is configured to only output a notification in response to an e-mail received from a specific sender. The foregoing are only a couple of examples of possible network and application events, and it should be understood that other network and application events are also within the scope of the present disclosure.

Once the device software completes callback registration for network and application events, it continues to block 720, where it waits for callback functions to be executed by the notifying device 110. When a callback function is invoked, the device software proceeds to block 724, where it will perform a number of checks. These checks include determining the type of callback, identifying the current states of the device software, and determining if there is a pending event that needs to be sent to the connected personal digital notification system 150.

A pending event is an application event that has an associated notification that was not sent to the personal digital notification system 150. There are several reasons why the notification may not have been sent to the personal digital notification system 150, including loss of connections or loss of Bluetooth radio signals. Pending events may include, for example, calls, messages and calendar events that occur when there is no connectivity between the device software and the personal digital notification system 150.

If there is a pending event, the device software will proceed to block 728. At block 728, the device software will connect to the personal digital notification system 150 via the Bluetooth transceiver 624 if the notifying device 110 is not yet connected. Furthermore, at block 728, the device software will also unpark the personal digital notification system 150 if it is parked, send a notification message to the personal digital notification system 150 via the notifying device's 110 Bluetooth transceiver, and park the personal digital notification system 150. Upon completing the foregoing, the device software will return to block 724. Blocks 724 and 728 are repeated for each pending event.

When it is determined at block 724 that there are no pending events, the device software will proceed to block 732. At block 732, the device software determines whether there are any application events for which a notification must be provided to the personal digital notification system 150. The device software determines this by identifying registered applications that have produced an event that has an associated notification. The device software may use the configuration values loaded at block 708 to determine whether there are any application events for which a notification must be provided to the personal digital notification system 150. If so, then the device software proceeds to block 728.

At block 728, the device software will unpark the personal digital notification system 150 if it is parked, send a notification message to the personal digital notification system 150 via the notifying device's 110 Bluetooth transceiver, and park the personal digital notification system 150. Blocks 732 and 728 are repeated for each application event that requires an associated notification. When there are no more application events that require an associated notification, the device software returns to block 720, and will proceed as described above.

Accordingly, the personal digital notification system operates at a reduced power consumption rate which prolongs battery life and battery recharge interval. Further, the user is less likely to miss an event notification from a plurality of mobile devices since the personal digital notification system is designed to be worn in close physical contact to the user so that alerts may be easily perceived in a noisy environment. In this manner, the user may store the mobile devices he/she uses in a purse or briefcase and still be able to easily detect an event notification.

Hardware generally includes at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards, for example.

Software includes any machine code stored in any memory medium, such as RAM or ROM, and machine code stored on other devices (such as floppy disks, flash memory, or a CD ROM, for example). Software may include source or object code, for example. In addition, software encompasses any set of instructions capable of being executed in a client machine or server.

Combinations of software and hardware could also be used for providing enhanced functionality and performance for certain embodiments of the disclosed invention. One example is to directly manufacture software functions into a silicon chip. Accordingly, it should be understood that combinations of hardware and software are also included within the definition of a computer system and are thus envisioned by the present disclosure as possible equivalent structures and equivalent methods.

Computer-readable mediums include passive data storage, such as a random access memory (RAM) as well as semi-permanent data storage such as a compact disk read only memory (CD-ROM). In addition, an embodiment of the invention may be embodied in the RAM of a computer to transform a standard computer into a new specific computing machine.

While different steps, processes, and procedures are described as appearing as distinct acts, it is understood that the steps, process, and procedures could also be performed in different orders, simultaneously, or sequentially. Additionally, the steps, processes, and procedures could be merged into one or more steps, processes, or procedures.

The manner of usage and operation of the present disclosure should be apparent to one of ordinary skill having the benefit of the present disclosure. The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the present disclosure has described embodiments relating to specific environments, it is understood that the apparatus, systems and methods described herein could applied to other environments.

In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. In the claims, means-plus-function clauses are intended to cover the structures described herein as performing the recited function and not only structural equivalents, but also equivalent structures.

What is claimed is:

1. An apparatus, comprising:
a connectivity transceiver configured to exchange data with a notifying device that is positioned within a signal distance of a signal transmitted by the connectivity transceiver;
a connectivity controller communicably coupled to the connectivity transceiver, the connectivity controller configured to code and decode data that is sent and received by the connectivity transceiver, the connectivity controller sets the signal distance to a reduced signal distance upon initiating a pairing operation with the notifying device;
a system controller communicably coupled to each of the connectivity transceiver and the connectivity controller, where the system controller is configured to control operation of each of the connectivity transceiver and the connectivity controller; and
an alert system outputs an alert when the connectivity controller receives a notification from the notifying device.

2. The apparatus of claim 1, wherein the reduced signal distance is approximately one inch upon initiating the pairing operation.

3. The apparatus of claim 1, wherein the connectivity controller increases the signal distance upon completion of the pairing operation.

4. The apparatus of claim 1, wherein the connectivity controller is configured to ignore an audio signal from the notifying device upon receiving a Synchronous Connection-Oriented (SCO) connection request from the notifying device.

5. The apparatus of claim 1, wherein the system controller is further configured to adjust an interval duty cycle of inquiry scans and page scans based on a connection with the notifying device.

6. The apparatus of claim 5, wherein the system controller is further configured to increase the interval duty cycle each time the system controller receives a connection inquiry from the notifying device.

7. The apparatus of claim 6, wherein the connection inquiry is performed in connection with a pairing operation.

8. The apparatus of claim 5, wherein the system controller is further configured to initiate a page scan duty cycle and incrementally reduce the page scan duty cycle upon responding to a connection inquiry.

9. The apparatus of claim 5, wherein the system controller is further configured to stop performing page scans upon entering a standby state, and resumes performing page scans when the connection with the notifying device is lost.

10. A method of operating a personal digital notification system device, the personal digital notification system device including a connectivity transceiver configured to exchange data with a notifying device positioned within a signal distance of a signal transmitted by the connectivity transceiver, the method comprising:
setting the signal distance to a reduced signal distance upon initiating a pairing operation with the notifying device; and
pairing the personal digital notification system device with the notifying device when it is positioned within the signal distance of the signal transmitted by the connectivity transceiver.

11. The method of claim 10, wherein the signal distance is less than approximately one inch.

12. The method of claim 10, further comprising increasing the signal distance upon completion of the pairing operation.

13. The method of claim 10, further comprising releasing a Synchronous Connection-Oriented (SCO) connection upon receiving an SCO request from the notifying device.

14. The method of claim 10, wherein the method further comprises adjusting an interval duty cycle of inquiry scans and page scans based on a connection with the notifying device.

15. A system, comprising:
at least one mobile device; and
a personal digital notification device worn in close physical contact with the user, and positioned within a predetermined signal distance to the at least one mobile device, wherein the personal digital notification device is configured to set the signal distance to a reduced signal distance upon initiating a pairing operation with the mobile device, the personal digital notification device being operable to provide an alert perceivable by the user upon receiving a notification from the at least one mobile device.

16. The system of claim 15, wherein the reduced signal distance is approximately one inch.

17. The system of claim 15, wherein the personal digital notification device is further configured to increase the signal distance upon completion of the pairing operation.

18. The system of claim 15, wherein the personal digital notification device is further configured to release a Synchronous Connection-Oriented (SCO) connection upon receiving an SCO request from the at least one mobile device.

19. The system of claim 15, wherein the personal digital notification device is configured to adjust an interval duty cycle of inquiry scans and page scans based on a connection with the at least one mobile device.

20. The system of claim 15, wherein the personal digital notification system device is configured to be attached to the user or user's personal effect selected from the group consisting of undergarment, bra, underwear, belt, waistband, shirt, shoe, sock, watch, hair, finger, wrist, glove, ear, head, and neck.

21. The system of claim 15, wherein the personal digital notification device is operable to pair and receive notification from a plurality of mobile devices.

22. The system of claim 15, wherein a first of the at least one mobile devices comprises a computer-readable medium having instructions executable by the processor, the instructions comprising:
instructions that register a callback function associated with an event;
instructions that execute the callback function when the event occurs; and
instructions that send a notification message to the personal digital notification device, the notification message informing the personal digital notification device of the event.

23. The system of claim 22, wherein the event is selected from a group consisting of an application event, and a network event.

24. The system of claim 22, further comprising instructions that identify a pending event; and
instructions that send a second notification message to the personal digital notification device, the second notification message informing the personal digital notification device of the pending event.

25. The system of claim 22, further comprising instructions that unpark the personal digital notification device prior to sending the notification message to the personal digital notification device; and
instructions that park the personal digital notification device after sending the notification message to the personal digital notification device.

26. The system of claim 22, wherein the first of the at least one mobile devices further comprises a memory, and the instructions further comprise:
instructions that load configuration values into the memory; and
instructions that use the configuration values to determine whether to execute the instructions that send the notification message.
